(19) United States
(12) Patent Application Publication
(10) Pub. No.: US 2004/0247095 A1
(43) Pub. Date: Dec. 9, 2004

(54) Domain name system for speech-based services

(76) Inventor: Bruno Fiter, Lannion (FR)

Correspondence Address: Siemens Corporation, Intellectual Property Department, 170 Wood Avenue South, Iselin, NJ, 08830, US

(21) Appl. No.: 10/493,128

(22) PCT Filed: Oct. 16, 2002
(86) PCT No.: PCT/DE02/03917

(30) Foreign Application Priority Data
Oct. 19, 2001 (DE) 101 51 718.1

(51) Int. Cl. H04M 11/00

(52) U.S. Cl. 379/88.18; 379/88.16

(57) ABSTRACT

The invention relates to a method according to which, in a speech-based service, a link is established between a user of said service and a speech service network server. According to the inventive method, the user of the service uses a short call number and a designation of the service to utilize said service. Using said short call number, the user establishes a link with the speech service network server and utilizes the designation of the service in the speech service network server to identify and start the service. The inventive system is particularly flexible when call numbers or services are changed, for the marketing of services and for the use of mnemonically obvious service designations.

### CROSS REFERENCE TO RELATED APPLICATIONS

This application is the US National Stage of International Application No. PCT/DE02/03917, filed Oct. 16, 2002 and claims the benefit thereof. The International Application claims the benefits of German application No. 10151718.1 filed Oct. 19, 2001, both of the applications are incorporated by reference herein in their entirety.

### FIELD OF INVENTION

The invention relates to a method for voice-based services according to which a connection is established between a service user and a voice service switching server within the framework of a voice-based service.

### BACKGROUND OF INVENTION

The convergence of different networks leads to new requirements in switching technology and Internet technologies in terms of the provision of efficient voice-based services.

Currently there are a plurality of voice-based services which can be called upon in the course of a voice connection. Services of this kind can, for example, include a through-connection to a call center, initiate an automatic voice output, access different types of content servers, i.e. servers providing information relevant to the service, or a combination of the above-mentioned elements.

In order to take account of the complexity of the service switching, servers were developed which coordinate and control the processes in voice-based services as well as access to content servers. A server of said kind—referred to in the following as a voice service switching server—is usually equipped with an IVR (Interactive Voice Response) functionality and is furnished with further means, such as voice recognition and software for converting textual information into speech information, in accordance with the data formats which are to be supported during access to content servers.

An example of a server with voice service switching functionality is the VoxPortal™ server developed by the company Siemens AG, information about which is available, for example, in the product description “VoxPortal™: A member of the SURPASS solution family”. The VoxPortal™ server supports the VoiceXML (Voice Extensible Markup Language) computer language for voice-based information output. The server can access content servers with data in different formats and using this data dynamically synthesizes a VoiceXML program script which is executed in the context of a voice service. The access to intent servers can be performed during an interactive voice dialog between service user and VoxPortal™ server as a function of the progression of the dialog.

With reference to FIG. 1, the switching or control of voice-based services can be illustrated with the aid of a voice service switching server VoxP. The user of the voice-based service initiates a voice connection with the voice service switching server. The VoxPortal™, for example, supports the establishment of connections on the service user side from mobile phones over the mobile radio network PLMN (Public Land Mobile Network), from fixed network telephones over the landline network PSTN (Public Switched Telephone Network) or ISDN (Integrated Services Digital Network) or Internet terminal devices by means of a voice connection VOIP (Voice over Internet Protocol) over the Internet. Within the framework of the service the voice service switching server VoxP can access information provided by a service provider.

FIG. 1 shows by way of example three content servers MAIL-S, HTML-S and XML-S which are accessible via the Internet, said content servers providing information in the form of email messages, HTML web pages or web information written in VoiceXML. The voice service switching Eerver VoxP accesses the information required for this in the content server, processes this information if necessary for voice output, and transfers it as voice information to the service user. However, the service switching can also consist in, for example, the voice service switching server VoxP connecting the service user to a call center—not shown in FIG. 1—via the fixed network.

A service can also include the combination of a plurality of switching and/or processing steps, for example access to a content server in conjunction with a through connection to a call center.

The use of a voice service switching server permits the creation, control and administration of complex voice-based services from different service providers.

### SUMMARY OF INVENTION

The object of the invention is to specify an efficient method for voice-based services implemented with the aid of a voice service switching server.

The object is achieved by the subject matter as recited in Claim 1.

In the method according to the invention, a voice-based service is assigned a short call number and a designation of the service. Using said short call number-consisting for example of 4 or 5 digits (Claim 7)—the service user establishes a connection to the voice service switching server. By voice input of the designation of the service by the service user, the service is identified in the voice service switching server and started (Claim 1). The identification of the service by means of the designation can take place in the course of a voice dialog between voice service switching server and service user. In the process the service user quotes the designation of the service, which designation is identified by means of voice recognition in the voice service switching server and assigned to the desired service (Claim 2). It is also possible, in the course of an interactive dialog, for the voice service switching server to offer the service user a predetermined plurality of designations of services ard for the service user to select a service by naming a service designation or by specifying a predetermined digit or digit sequence proposed together with the designation (Claim 3 and Claim 4).

According to the invention, the information for identification of a service, which traditionally consists of a call number, is replaced by a two-part service identification which is formed by a short call number and a service designation. By analogy with transmission in data networks and with the “Domain Name System” used in the Internet, the term “address” is also used in the following for the service identification information for illustration purposes. The second part of the service identification information or service address is addressed symbolically, that is to say by means of a service designation. The inventive use of a service designation as part of the address permits a considerably higher degree of addressing flexibility. Arbitrary real address information, such as, for example, call numbers, URL (Universal Resource Locator) addresses etc. can be assigned to the symbolic part of the address, i.e. the service designation. The service address and in particular its first part, the short call number, is therefore independent of the real addresses that are used for the transmission of information between the voice service switching server and facilities of the service provider, such as content servers and call centers. This addressing or selection of service identification information has an advantageous effect for example in the reassignment of or changes to call numbers. A change of call number can take place for example in the course of changes to services. Generally there is a higher degree of flexibility in the modification, conversion, linking and expansion of voice-based services.

The invention permits a better definition of interfaces or demarcations-between service user and voice service switching server as well as between voice service switching server and any facilities of the service provider, such as content servers and call centers. It allows the access by the service user to be decoupled from the real implementation of the service by the service provider. As a result administration is simplified. In many cases the voice service switching server is administered by the network operator—referred to in the following as the carrier—as a result of which two separate interfaces are provided between service user and carrier on the one hand and carrier and service provider on the other.

The service providers can select mnemonically favorable service designations for their services. On the one hand this enables them to market their services more effectively, and on the other hand it is easier for the service user to remember the service address, i.e. the short call number and the service designation.

The two parts of the address can be assigned additional functions independently of each other and have a different scope. In cases where the voice service switching server is operated by a carrier, the customer can for example be billed by the carrier in accordance with the selected short call number. The carrier then transfers a percentage of the charges levied in the context of voice-related services to the service provider in accordance with the frequency with which the service is used (Claim 11). In this case the charges billed to the service user can be linked to the call number (Claim 12). This type of charging is simple and efficient, in particular in the context of the convergence of many services and service providers in the voice service switching server.

The service designation can possess a more global validity than the short call number, for example when there are provided a plurality of voice service switching servers by means of which the service can be performed, and the service has the same service designation across these voice service switching servers (Claim 14). For example, the service designation can be marketed by a service provider with total coverage in a region which is too small for the provision of a service by means of one of these voice service switching servers. In such a case there may also be a plurality of content servers or call centers in which the information provided as part of the service is available (Claim 15). A service name of this kind which is used over a broad front—possibly in a number of languages—may be entered in a register provided specially for the purpose or protected by trademark law (Claim 13). A use of the service name in a similar way to the names used in the Domain Name System of the Internet is conceivable.

Further advantageous developments of the subject matter of the invention are specified in the other subclaims.

### BRIEF DESCRIPTION OF THE DRAWINGS

The invention will be explained in more detail in the following with reference to exemplary embodiments and the drawing, in which:

FIG. 1: shows a system with voice service switching server

FIG. 2: shows a system with voice service control by a void service switching server

FIG. 3: shows a charging model for a system with voice service switching server

Like reference symbols in the various drawings indicate like elements.

### DETAILED DESCRIPTION OF INVENTION

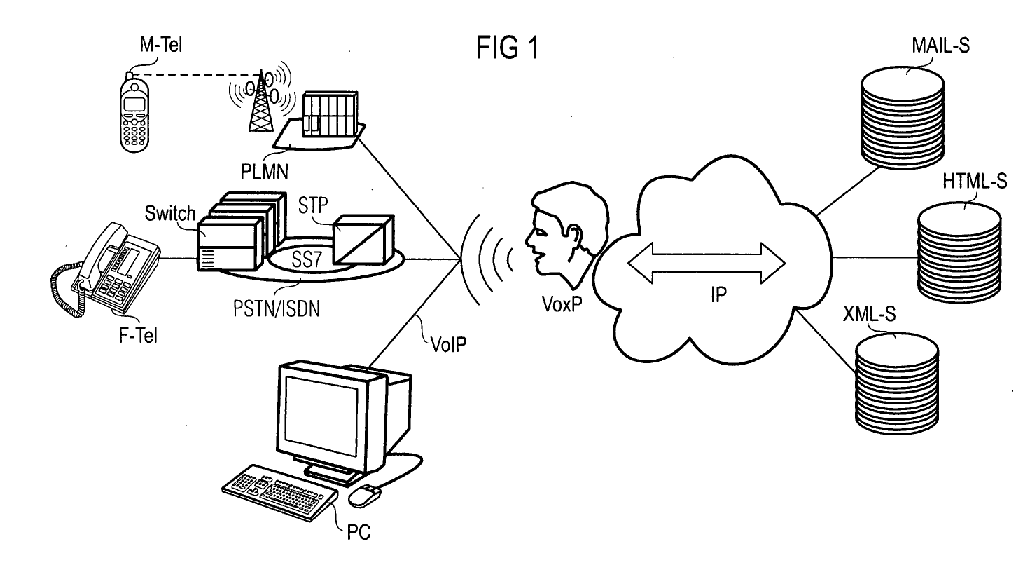

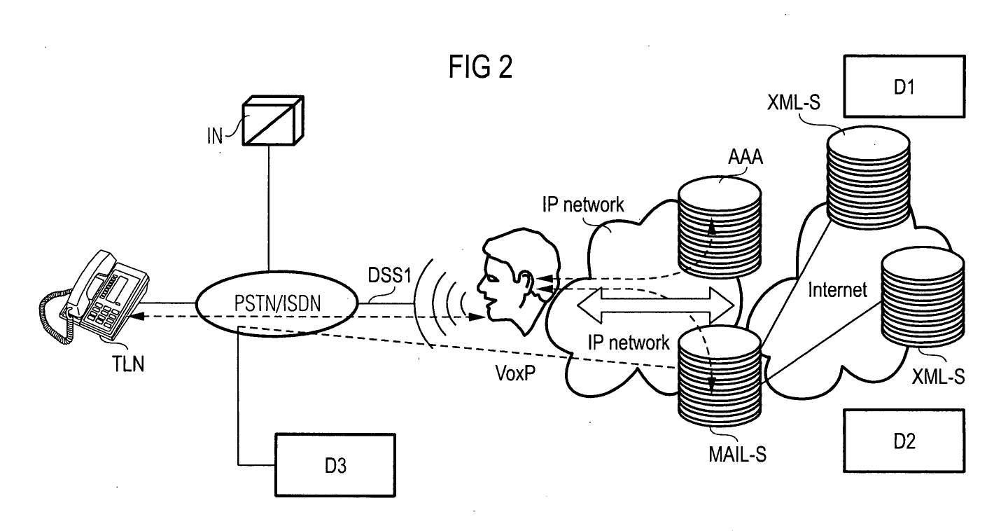

FIG. 2 depicts a system comprising a server VoxP having the voice service switching functionality explained in connection with FIG. 1. This voice service switching server is connected by means of the IP (Internet Protocol) protocol to two servers which provide resources for functions of the voice service switching server VoxP. One of the two servers is what is known as an AAA (Authentication, Authorization and Accounting) server and contains means for checking access authorizations and for accounting of services. The second server XML-S provides resources for VoiceXML applications such as, for example, voice recognition. The service user TLN is connected to the voice service switching server via fixed network PSTN/ISDN. The connection is established using the DSS1 (Digital Signaling System No. 1) protocol employed in ISDN networks. Three services D1, D2 and D3 are shown in FIG. 2. Web information written in VoiceXML can be downloaded via the Internet in the context of the services D1 and D2. In a third service D3, the service user's call is forwarded via the fixed network PSTN/ISDN by the voice service switching server.

The service D3 is provided for example by a call center. For the purpose of forwarding calls to the call center, the voice service switching server VoxP has a certain call number repertory. According to the invention, the service user can now initiate the service by means of just one short call number and a service designation. The voice service switching server VoxP then uses a call number from its call number repertory. In the event of a change, for example an extension, to the call number repertory for the call center, there is no need to change the information for identification of the service, i.e. the short call number and the service designation, that is available to the service user. Symbolic addressing by means of a service name permits the change to be made by a new assignment of call numbers to the service name. The change remains hidden from the service user.

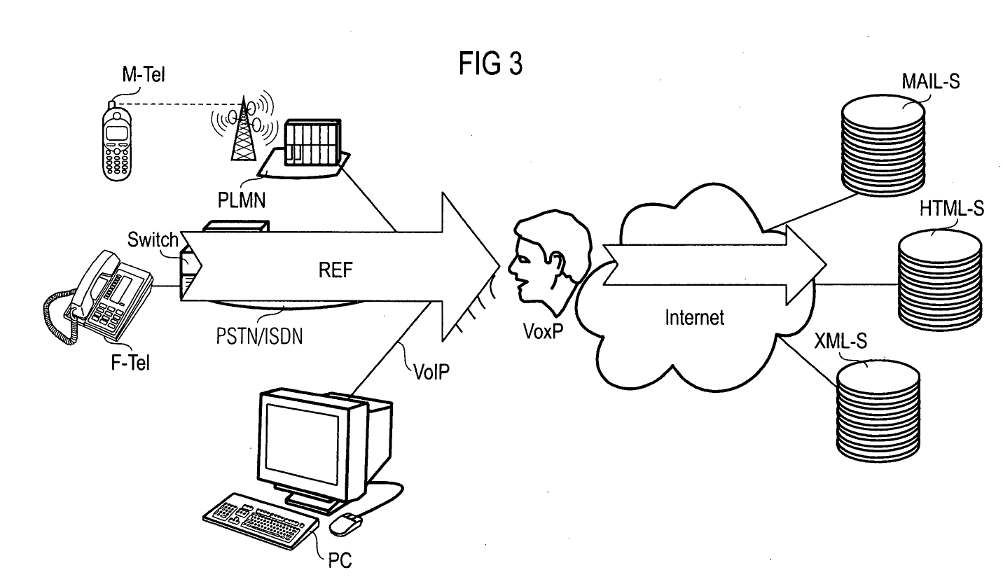

FIG. 3 depicts how the charging can be accomplished according to the invention. Using a mobile phone M-Tel, a fixed network telephone F-Tel or an Internet terminal device PC, the service user sets up a connection to the voice service switching server VoxP. In accordance with the short call number used for this, which may also be different depending on the terminal device M-Tel, F-Tel or PC used, the service user is charged by the voice service switching server VoxP or the carrier. This charging is indicated in the Figure by an arrow with the reference symbol REV (REV: for revenue). The administration of the voice service switching server or the carrier transfers a percentage of the charges levied in the context of voice-related services to the service provider according to the frequency with which the service is used—indicated in the Figure by the arrow with the reference symbol REVCP (for: revenue content provider). The figure shows three service providers—often also referred to as Internet Service Providers or Content Providers—which can be accessed via the Internet and which provide information available in the server MAIL-S, HTML-S and XML-S in the form of email messages, HTML web pages or web information written in VoiceXML.

1-15. (canceled)

16. A method for voice-based services according to which a connection is established between a service user and a voice service switching server within the framework of a voice-based service, the method comprising:
assigning a short call number and a designation to a service;
establishing a connection to the voice service switching server by a service user, using the short call number;
identifying the service to the voice service switching server by the service user by voice input of the designation; and
starting the service.

17. The method according to claim 16, wherein
a voice dialog is started between the voice service switching server and the service user, wherein
the service user inputs the designation of the service in the course of the dialog by quoting the name, and wherein
the desired service is identified by voice recognition in the voice service switching server.

18. The method according to claim 16, wherein in the course of an interactive dialog, the voice service switching server quotes a plurality of service designations to the service user, and the service user selects a service by quoting a service designation or by specifying a digit or digit sequence.

19. The method according to claim 16, wherein in the course of an interactive dialog, the voice service switching server quotes to the service user a plurality of service designations and digits or digit sequences assigned to the designations, and the service user selects a service by quoting the digit or digit sequence assigned to the service.

20. The method according to claim 16, wherein information provided by a service provider is accessed by the voice service switching server in the context of the service, and the information provided by the service provider is processed in the voice service switching server for voice output.

21. The method according to claim 16, wherein textual information is converted into speech information and/or information provided by a service provider is combined with voice information provided in the voice service switching server for the dialog with the service user.

22. The method according to claim 16, wherein a short call number consisting of 4 or 5 digits is used.

23. The method according to claim 16, wherein email messages, HTML web pages or web information written in VoiceXML provided by a service provider in a content server are accessed via the Internet in the context of the service provided by the voice service switching server.

24. The method according to claim 16, wherein a fixed network connection is switched to a call center in the context of the service.

25. The method according to claim 16, wherein the service user initiates the connection to the voice service switching server using a mobile phone, a fixed network telephone or an Internet terminal device in the context of a voice transmission over the Internet.

26. The method according to claim 16, wherein
the voice service switching server (VoxP) is operated by a carrier,
charges are billed to the service user by the carrier in accordance with the service selected, and

27. The method according to claim 26, wherein the service user is charged in accordance with the short number selected.

28. The method according to claim 16, wherein a service name is used which is entered in a register with names of the same kind or is protected by trademark law.

29. An arrangement for performing a method for voice-based services according to which a connection is established between a service user and a voice service switching server within the framework of a voice-based service, the method comprising:
assigning a short call number and a designation to a service;
establishing a connection to the voice service switching server by a service user, using the short call number;
identifying the service to the voice service switching server by the service user by voice input of the designation; and
starting the service, wherein the arrangement comprises a plurality of voice service switching servers to perform a service, wherein the service has the same service designation across said voice service switching servers.

30. The arrangement according to claim 29, wherein information is provided or can be downloaded in the context of the service, and a plurality of content servers or call centers are provided in which the information provided in the context of the service is available.
